(19) United States
(12) Patent Application Publication
(10) Pub. No.: US 2012/0120150 A1
(43) Pub. Date: May 17, 2012

(54) LIQUID EJECTION DEVICE

(75) Inventor: Masaaki ANDO, Shiojiri (JP)

(73) Assignee: SEIKO EPSON CORPORATION, Tokyo (JP)

(21) Appl. No.: 13/286,449

(22) Filed: Nov. 1, 2011

(30) Foreign Application Priority Data
Nov. 11, 2010 (JP) 2010-252870

(51) Int. Cl. B41J 2/165

(52) U.S. Cl. 347/22

(57) ABSTRACT

A liquid ejection device includes: a support member configured and arranged to support a conveyed medium conveyed in a predetermined direction; a liquid ejection head having an ejection surface facing the support member with the ejection surface having a plurality of nozzles for ejecting a liquid onto the conveyed medium; and a protecting member provided between the ejecting surface and the conveyed medium, arranged in a position fixed relative to the support member, and having an open part that allows passage of the liquid ejected from the liquid ejection head.

### CROSS-REFERENCE TO RELATED APPLICATIONS

This application claims priority to Japanese Patent Application No. 2010-252870 filed on Nov. 11, 2010. The entire disclosure of Japanese Patent Application No. 2010-252870 is hereby incorporated herein by reference.

### BACKGROUND

1. Technical Field

The present invention relates to a liquid ejection device.

2. Related Art

Inkjet recording devices and the like which record characters, images, etc. on a recording medium, for example, are known as liquid ejection devices for ejecting a liquid. An inkjet recording device is configured to perform recording on a recording medium by ejecting ink onto the recording medium from nozzles provided to an ejection head while conveying the recording medium (e.g., Japanese Laid-Open Patent Publication No. 2005-280241).

### SUMMARY

However, when ink is ejected from the head, sometimes an ink mist is produced by the air pressure that accompanies the discharge of ink from the nozzles, the depositing of ink on the recording medium, and other ink-ejecting actions. When the ink mist adheres to the ink ejection surface of the ejection head, the ink ejection surface is fouled.

In view of the circumstances described above, an object of the present invention is to provide a liquid ejection device in which the fouling of the ejection surface of a liquid ejection head can be prevented.

A liquid ejection device according to a first aspect of the present invention includes a support member, a liquid ejection head and a protecting member. The support member is configured and arranged to support a conveyed medium conveyed in a predetermined direction. The liquid ejection head has an ejection surface facing the support member, the ejection surface having a plurality of nozzles for ejecting a liquid onto the conveyed medium. The protecting member is provided between the ejecting surface and the conveyed medium, arranged in a position fixed relative to the support member, and having an open part that allows passage of the liquid ejected from the liquid ejection head.

According to this aspect, since a protecting member is provided between the ejection surface and the conveyed medium, liquid in the faun of mist produced on the conveyed medium during ejection by the liquid ejection head, for example, can be prevented from adhering to the ejection surface. Since an open part is provided for allowing the ejected liquid to pass through, the ejecting action by the liquid ejection head is not hindered. Additionally, when there is mist between the ejection surface and the protecting member, for example, some of the mist can be made to adhere to the protecting member, and the adhering of the mist on the ejection surface can therefore be kept to a minimum.

In the liquid ejection device described above, the nozzles are preferably arranged in one direction, and the open part has a slit shape in an area corresponding to the nozzles.

According to this aspect, since the nozzles are arranged in one direction and the open part is formed into a slit shape in an area corresponding to the nozzles, the surface area of the open part can be made as small as possible. The mist can thereby be inhibited from entering the ejection surface through the open part.

In the liquid ejection device described above, the protecting member preferably has a closing part that contacts at least an end in the predetermined direction of the liquid ejection head to close off a space between the ejection surface and the protecting member.

According to this aspect, since the space between the ejection surface and the protecting member can be closed off by the closing part, the produced mist can be prevented from entering through the space between the ejection surface and the protecting member.

In the liquid ejection device described above, the closing part is preferably also a positioning part between the liquid ejection head and the protecting member.

According to this aspect, since the closing part performs positioning between the liquid ejection head and the protecting member by coming in contact with the end, the position of the liquid ejection head and the position of the protecting member can be regulated by a simple action.

In the liquid ejection device described above, the protecting member is preferably made of a porous material configured to absorb the liquid.

According to this aspect, since the protecting member is formed using a porous material capable of absorbing liquid, liquid such as mist adhering to the protecting member can be absorbed. The liquid can thereby be prevented from flowing out.

In the liquid ejection device described above, the protecting member preferably has an absorbing member provided to an area separated from the open part to absorb the liquid.

According to this aspect, since the protecting member has an absorbing member capable of absorbing liquid, liquid such as mist adhering to the protecting member can be absorbed. The liquid can thereby be prevented from flowing out. Since the absorbing member is provided to an area separated from the open part, it does not hinder the ejecting action of the liquid ejection head.

The liquid ejection device described above preferably further includes a recovery part configured and arranged to recover the absorbed liquid.

According to this aspect, since a recovery part is provided for recovering the absorbed liquid, the protecting member or the absorbing member can be kept clean. The absorbing action by the protecting member or the absorbing member can thereby be continued.

In the liquid ejection device described above, the protecting member preferably has an inclined part configured and arranged to guide the liquid from the open part toward the recovery part.

According to this aspect, since the protecting member has an inclined part for guiding the liquid from the open part toward the recovery part, the liquid adhering to the protecting member easily reaches the recovery part. The efficiency of recovering the liquid can thereby be increased.

In the liquid ejection device described above, the recovery part is preferably provided to an end of the protecting member in the predetermined direction in which the conveyed medium is conveyed.

According to this aspect, since the recovery part is provided to the end of the protecting member in the direction in which the conveyed medium is conveyed, it is easy to design a recovery system including a liquid flow passage.

In the liquid ejection device described above, the protecting member preferably has a protruding part protruding from a peripheral edge of the open part toward at least one of the liquid ejection head and the conveyed medium.

According to this aspect, when a protruding part protrudes toward the liquid ejection head, it is easier to perform cleaning and other maintenance on the protecting member, for example. When a protruding part protrudes toward the conveyed medium, mist can be more efficiently prevented from entering the ejection surface.

The liquid ejection device described above preferably further includes a fixing member fixing the support member and the protecting member.

According to this aspect, since the liquid ejection head further includes a fixing member for fixing the support member and the protecting member, the positions of the support member and the protecting member can be stabilized.

The liquid ejection device described above preferably further includes a brace member attached to the fixing member and extending in a direction perpendicular to the ejection surface. The liquid ejection head is configured and arranged to move along a direction in which the brace member extends.

According to this aspect, since the liquid ejection head is capable of moving along the direction in which the brace member extends, the brace member being attached to the fixing member and extending in a direction perpendicular to the ejection surface, positioning of the ejection surface and the protecting member can be performed by moving the liquid ejection head even when the position of the protecting member is fixed.

The liquid ejection device described above preferably further includes a head drive mechanism configured and arranged to move the liquid ejection head along the direction in which the brace member extends. The head drive mechanism is preferably also a detaching mechanism configured and arranged to move the liquid ejection head to detach the liquid ejection head from the protecting member.

According to this aspect, since the head drive mechanism is also a detaching mechanism for moving the liquid ejection head and thereby detaching the liquid ejection head from the protecting member, it is easy to set the positional relationship between the ejection surface and the protecting member.

### BRIEF DESCRIPTION OF THE DRAWINGS

Referring now to the attached drawings which form a part of this original disclosure:

FIG. 1 is a schematic view showing the configuration of a printing device according to an embodiment of the present invention;

FIG. 2 is a partial plan view of the periphery of an ejection head;

FIG. 3 is a plan view showing a nozzle opening formation surface of an ejection head;

FIG. 4 is a drawing showing the cross-sectional configuration of the ejection head;

FIG. 5A is a cross-sectional view showing the schematic configuration of the protecting member, and FIG. 5B is an underside view showing the schematic configuration of the protecting member;

FIG. 6A is a front view showing the schematic configuration of the protecting member and the ejection head, and FIG. 6B is a plan view showing the schematic configuration of the protecting member and the ejection head;

FIG. 7 is a block diagram showing the configuration of the printing device;

FIG. 8 is a drawing showing the action of the printing device;

FIG. 9 is a schematic drawing showing another configuration of the printing device according to the present invention;

FIG. 10 is a schematic drawing showing another configuration of the printing device according to the present invention;

FIG. 11 is a schematic drawing showing another configuration of the printing device according to the present invention;

FIG. 12 is a schematic drawing showing another configuration of the printing device according to the present invention;

FIG. 13 is a schematic drawing showing another configuration of the printing device according to the present invention; and

FIG. 14 is a schematic drawing showing another configuration of the printing device according to the present invention.

### DETAILED DESCRIPTION OF EXEMPLARY EMBODIMENTS

Embodiments of the liquid ejection device according to the present invention are described hereinbelow based on the accompanying drawings. To make the members of the liquid ejection device large enough to be recognizable, the drawings used in the descriptions hereinbelow show the members as being scaled appropriately. In the present embodiment, the description uses an inkjet printing device as an example of a liquid ejection device.

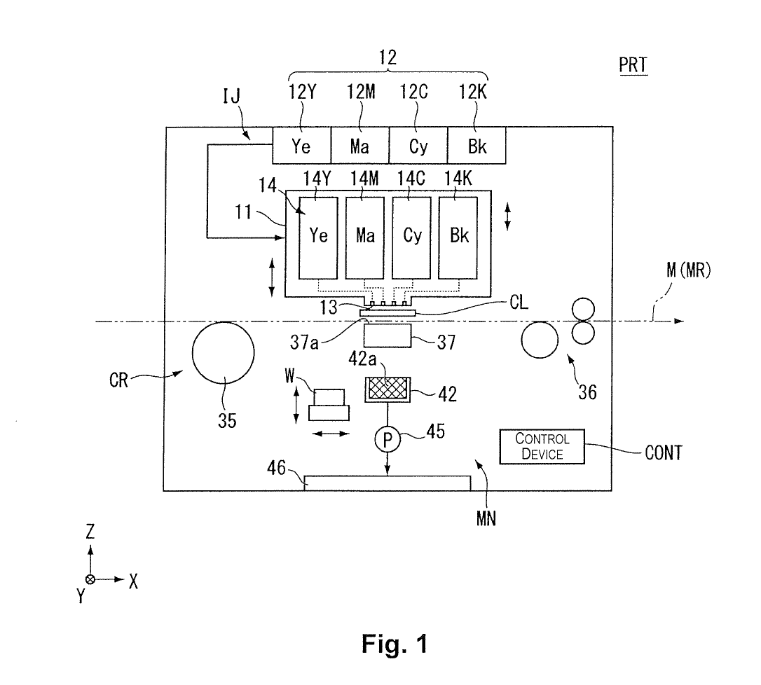

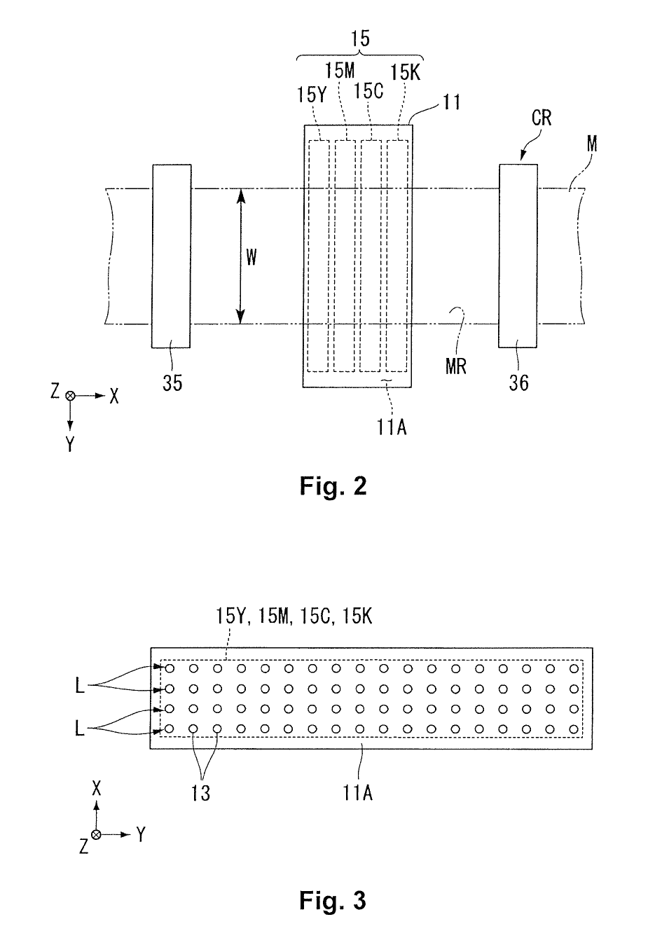

FIG. 1 is a schematic structural view of an inkjet printer (hereinbelow represented as a printing device PRT) of the present embodiment. FIG. 2 is a partial plan view of the periphery of an ejection head. FIG. 3 is a plan view showing a nozzle opening formation surface of an ejection head.

FIG. 1 is a case in which an XYZ orthogonal coordinate system is set up, and this XYZ coordinate system is referenced to describe the member positioning relationship. In this case, the direction in which a recording medium M is conveyed is the X direction (the left-right direction in FIG. 1), the direction perpendicular to a nozzle formation area 15 of an ejection head 11 is the Z direction (the up-down direction in FIG. 1), and the direction perpendicular to the XZ plane formed by the X direction axis and the Z direction axis is the Y direction (the image plane depth direction in FIG. 1).

The printing device PRT is a device for recording images, characters, and the like on the recording medium M as shown in these drawings. Paper, plastic, or the like, for example, is used as the recording medium M. The printing device PRT has an ink ejection mechanism IJ, a conveying mechanism CR, a protecting member CL, a maintenance mechanism MN, and a control device CONT.

The ink ejection mechanism IJ is a portion for ejecting ink droplets (a fluid) onto the recording medium M. The ink ejection mechanism IJ has an ejection head (a fluid ejection head) 11 and an ink supplier 12. The ink used in the present embodiment is a liquid having dyes, pigments, and solvents for dissolving or dispersing the dyes and pigments as essential constituents, and various additives are added as necessary.

The ejection head 11 is a head capable of ejecting multiple colors of ink droplets onto the recording medium M. The ejection head 11 is a line-type ejection head having a nozzle formation area 15 across a length (maximum recording paper width W) going past at least one edge of a maximum-sized recording medium M used by the printing device PRT, as shown in FIG. 2, for example. The ejection head 11 is provided to be capable of moving in the Z direction, for example. The ejection head 11 has nozzles 13 and a common ink chamber 14.

The common ink chamber 14 holds ink (common ink chambers 14Y, 14M, 14C, 14K) corresponding to four colors (yellow: Y, magenta: M, cyan: C, black: K), for example. The nozzle formation area 15 is provided corresponding to the common ink chamber 14 of each aforementioned color (nozzle formation areas 15Y, 15M, 15C, 15K).

The nozzles 13 are provided in a plurality to each of the nozzle formation areas 15Y, 15M, 15C, 15K of the ejection head 11, and are open parts for discharging ink droplets of the four aforementioned colors, for example. The nozzles 13 are arrayed in pluralities (nozzle rows L) in the Y direction as shown in FIG. 3, for example. One or more nozzle rows L are provided for the nozzle formation areas 15Y, 15M, 15C, 15K of each color. The number of nozzles 13 and the number of nozzle rows L are set appropriately. The surface of the ejection head 11 that contains the nozzles 13 is an ejection surface 11A. The ejection surface 11A is provided on the −Z side of the ejection head 11. The ejection head 11 is designed to eject ink droplets to the −Z side.

The conveying mechanism CR has a paper-feeding roller 35, a discharge roller 36, a support member 37, and other members. The paper-feeding roller 35 and the discharge roller 36 are rotatably driven by a motor mechanism (not shown). The support member 37 is placed in a conveying route MR of the recording medium M, and the support member 37 has a support surface 37a for supporting the recording medium M.

The support member 37 is placed on the −Z side of the ejection head 11. The support surface 37a faces toward the ejection head 11, i.e. toward the +Z side. In such a configuration, the ejection head 11 has a configuration in which ink is ejected onto the recording medium M which is being supported on the support member 37. The conveying mechanism CR conveys the recording medium M along the conveying route MR in conjunction with the ink droplet ejecting action of the ink ejection mechanism IJ.

The maintenance mechanism MN performs maintenance of the ejection head 11. The maintenance mechanism MN has a cap member 42, a suction mechanism 45, an ink discharge tank 46, and a wiping member W. The cap member 42 is a tray-shaped member for capping the ejection surface 11A of the ejection head 11. The cap member 42 is a portion for receiving the discharged ink when a discharge action is performed for discharging ink that has become highly viscous in the nozzles 13.

The cap member 42 has an ink-absorbing member 42a within the tray. The bottom part of the cap member 42 is provided with an open part 42b. The suction mechanism 45 has a pump or another suction source, for example, and the suction mechanism 45 is connected to the open part 42b of the cap member 42. The suction mechanism 45 suctions out the interior of the cap member 42 and suctions out the ink that has collected in the cap member 42.

The ink discharge tank 46 is a portion for discharging the ink that has collected in the cap member 42. The ink discharge tank 46 is placed at the end of the −Z side of the printing device PRT, for example, and is capable of being attached and removed. The ink discharge tank 46 is connected to the downstream side of the suction mechanism 45, for example. The wiping member W wipes off the ejection surface 11A and other members. The wiping member W is capable of moving in the X direction, the Y direction, and the Z direction so that it can be accessed from the side near the ejection head 11.

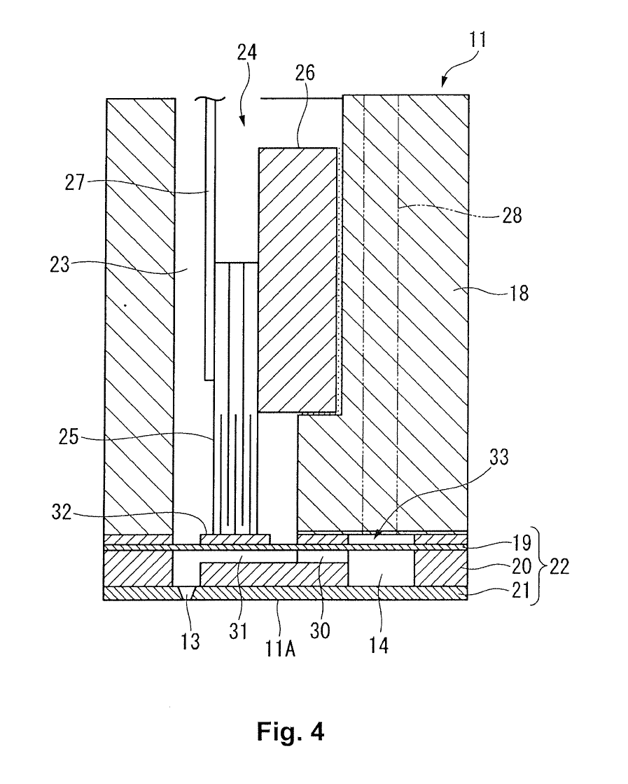

FIG. 4 is a cross-sectional view showing the configuration of the ejection head 11.

The ejection head 11 comprises a head main body 18, and a flow passage formation unit 22 connected to the head main body 18, as shown in FIG. 4. The flow passage formation unit 22 comprises a vibrating plate 19, a flow passage substrate 20, and a nozzle substrate 21.

The head main body 18 is a box-shaped member made of a synthetic resin. Formed in the head main body 18 are an accommodating chamber 23 for accommodating a drive unit 24, and an internal flow passage 28 for guiding ink supplied from the exterior to the flow passage formation unit 22.

The drive unit 24 placed inside the accommodating chamber 23 comprises a plurality of piezoelectric elements 25, a fixing member 26 for supporting the top ends of the piezoelectric elements 25, and a flexible cable 27 for supplying drive signals to the piezoelectric elements 25. The piezoelectric elements 25 are provided corresponding to the respective nozzles 13.

The internal flow passage 28 is formed through the head main body 18 in the up-down direction in FIG. 4. The internal flow passage 28 is an ink flow passage which allows ink supplied from the ink supplier 12 to flow to the flow passage formation unit 22 via an open end in the lower end of the drawing.

The flow passage formation unit 22 has a configuration in which the vibrating plate 19, the flow passage substrate 20, and the nozzle substrate 21 are stacked and integrally bonded together by an adhesive or the like. The flow passage formation unit 22 comprises the common ink chamber 14 which is connected to the internal flow passage 28 of the head main body 18, an ink supply port 30 connected to the common ink chamber 14, and pressure chambers 31 connected to the ink supply port 30. The pressure chambers 31 are provided corresponding to the respective nozzles 13. Each of the pressure chambers 31 is connected to the nozzles 13 in the side opposite the common ink chamber 14.

The vibrating plate 19 has a configuration in which an elastic film is laminated over a metal support plate made of stainless steel or the like, for example. An insular part 32 is formed in a section of the vibrating plate corresponding to the pressure chambers 31. The insular part 32 is bonded to the bottom ends of the piezoelectric elements 25 by removing part of the support plate to form a ring shape by etching or the like, for example.

The insular part 32 functions as a diaphragm. The vibrating plate 19 is designed so that the portion of the elastic film surrounding the insular part 32 over the pressure chambers 31 elastically deforms according to the vibration of the piezoelectric elements 25, and the insular part 32 moves up and down. A portion where part of the supporting plate is removed to leave only the elastic film is provided between the vibrating plate 19 and the bottom end vicinity of the internal flow passage 28 as well, and the portion constitutes a compliance part 33 for absorbing the pressure vibrations within the common ink chamber 14.

The flow passage substrate 20 has concave parts for forming the common ink chamber 14 which connects the bottom end of the internal flow passage 28 and the nozzles 13, the ink supply port 30, the pressure chambers 31, and other ink flow chambers. These concave parts are formed by anisotropic etching of the silicon monocrystalline substrate constituting the substrate of the flow passage substrate 20.

The nozzle substrate 21 has a plurality of nozzles 13 formed at predetermined intervals (pitch) in a predetermined direction. The nozzle substrate 21 of the present embodiment is a plate-shaped member formed from stainless steel, for example, or another metal. The outer surface of the nozzle substrate 21 is the ejection surface 11A.

The ejection head 11 having the above construction is designed so that the piezoelectric elements 25 expand and contract due to drive signals being inputted to the piezoelectric elements 25 via the cable 27. The expanding and contracting of the piezoelectric elements 25 are transmitted as deformation of the vibrating plate 19 (deformation in a direction toward the cavities and a direction away from the cavities). The deforming of the vibrating plate 19 causes the volumes of the pressure chambers 31 to change and the pressures of the pressure chambers 31 accommodating in to fluctuate. Ink is ejected from the nozzles 13 by this pressure fluctuation.

The ejection head 11 is also provided with a pressurizing mechanism (not shown). Through the increase in pressure caused by this pressurizing mechanism in addition to the expanding and contracting of the piezoelectric elements 25, ink is ejected from the nozzles 13. Therefore, the ejection head 11 is configured without a sub-tank or the like.

Returning to FIG. 1, the protecting member CL is placed between the ejection head 11 and the recording medium M supported on the support member 37. The protecting member CL prevents mist, which is produced when ink is ejected from the ejection head 11, from adhering to the ejection surface 11A. The protecting member CL is formed into a plate shape from a polyolefin-based hydrophilic porous sintered mold or the like, for example, and its position is fixed relative to the support member 37. Therefore, the protecting member CL is configured to be capable of absorbing and holding a certain amount of ink

The protecting member CL is connected to a raising/lowering mechanism (a second movement mechanism) AC2 which moves the protecting member CL in the Z direction relative to the ejection head 11, for example. The raising/lowering mechanism AC2 is fixed to a guide part G1 extending in the Z direction, for example, and to the support member 37 along the guide part G1, i.e. via a fixing member (not shown).

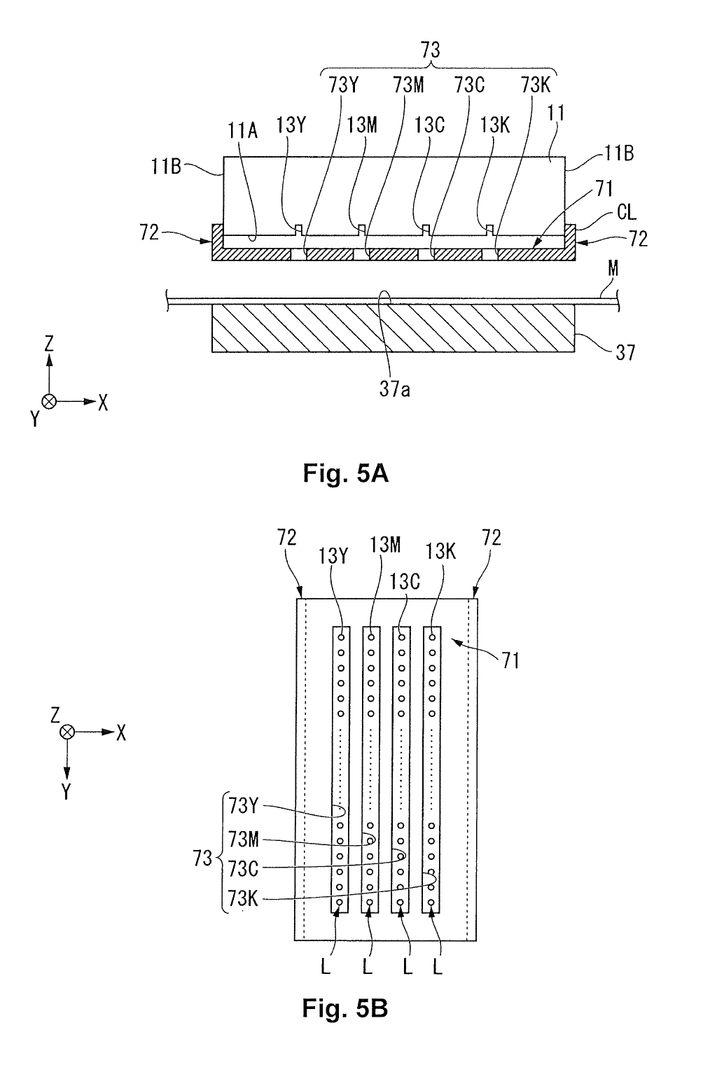

FIG. 5A is a cross-sectional view showing the configuration of the protecting member CL. FIG. 5B is an underside view showing the configuration of the protecting member CL.

The protecting member CL has a facing part 71, closing parts 72, and open parts 73, as shown in FIGS. 5A and 5B. The facing part 71 is a portion which is provided to a position facing the ejection surface 11A of the ejection head 11 and which covers the ejection surface 11A. The facing part 71 is formed into a flat plate shape, for example.

The closing parts 72 are in contact with end parts 11B of the ejection head 11 in the conveying direction (the X direction) of the recording medium M. The closing parts 72 on the +Y side and the −Y side come in contact with the end parts 11B on the +Y side and the −Y side, respectively, whereby they are positioned between the ejection head 11 and the protecting member CL. The closing parts 72 are formed to be capable of being attached to and removed from the end parts 11B.

The facing part 71 and the closing parts 72 are formed across the entire ejection head 11 in the Y direction as shown in FIG. 5B. Therefore, the +X end and the −X end of the ejection head 11 are closed by the closing parts 72 of the protecting member CL entirely through the Y direction. Therefore, the configuration inhibits mist from readily leaking out in the +X end and the −X end of the ejection head 11.

The open parts 73 are provided in positions corresponding to the nozzle rows L of the ejection head 11 within the facing part 71. The open parts 73 are formed into slit shapes aligned longitudinally in the Y direction, for example, so as to expose all of the nozzles 13 constituting the nozzle rows L. Four open parts 73 are aligned in the X direction corresponding to the four nozzle rows L.

The open parts 73 are formed entirely through the nozzle rows L in the Y direction so that all of the nozzles 13 constituting the nozzle rows L are exposed when viewed from the −Z direction. Thus, the open parts 73 are formed corresponding to the positions of the nozzles 13. When the four open parts 73 are distinguished hereinbelow, they are referenced respectively as the open parts 73Y, 73M, 73C, and 73K from the −X side to the +X side as shown in FIGS. 5A and 5B.

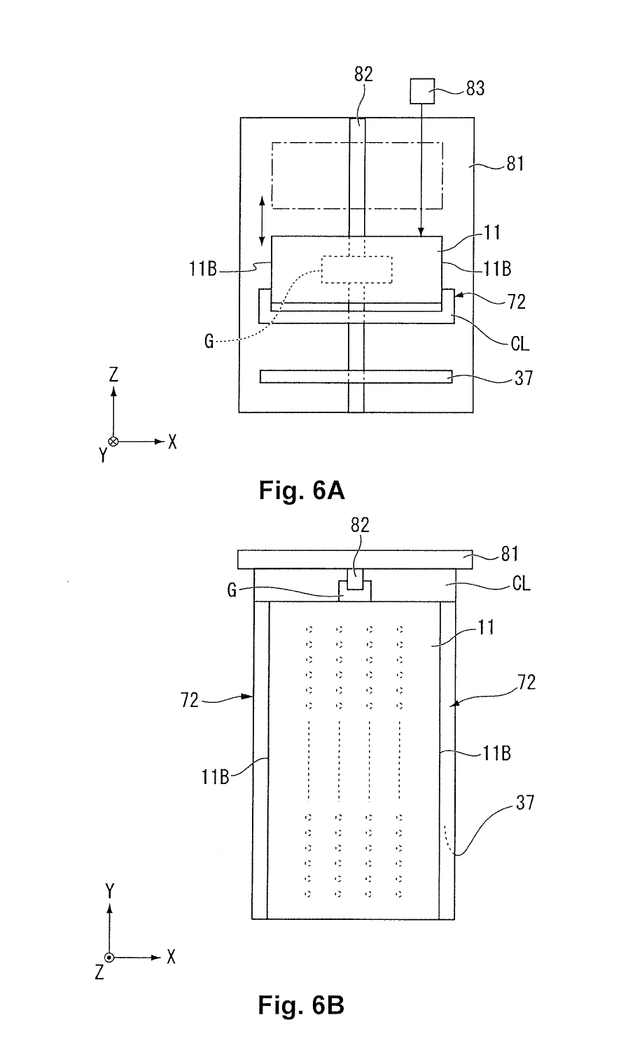

FIG. 6A is a front view showing the configuration of the protecting member CL and the ejection head 11. FIG. 6B is a plan view showing the configuration of the protecting member CL and the ejection head 11.

The +Y end of the ejection head 11 is connected to a brace member 82 via a guide mechanism G as shown in FIGS. 6A and 6B.

The brace member 82 is attached to a wall plate member 81 so as to extend in the Z direction. The aforementioned +Y end of the protecting member CL is fixed to the wall plate member 81. The +Y side of the support member 37 is also fixed to the wall plate member 81. Therefore, the protecting member CL and the support member 37 are fixed via the wall plate member 81.

The brace component 82 is placed so as to pass through the protecting member CL and the support member 37 in the Z direction. The guide mechanism G guides the movement of the ejection head 11 in the Z direction along the brace component 82. The guide mechanism G is connected to a head drive mechanism 83. The head drive mechanism 83 is a linear motor mechanism, an air cylinder mechanism, or another actuator, for example. The head drive mechanism 83 moves the guide mechanism G along the Z direction by the control of the control device CONT, for example. Thus, the ejection head 11 is provided to be capable of moving in the Z direction by the driving of the head drive mechanism 83.

When the ejection head 11 moves in the −Z direction by the driving of the head drive mechanism 83, the ejection head 11 becomes mounted on the protecting member CL. When the ejection head 11 moves in the +Z direction from this state, it is released from being mounted on the protecting member CL. Thus, the head drive mechanism 83 is configured to also be a detaching mechanism for detaching the ejection head 11 from the protecting member CL.

When the ejection head 11 is mounted on the protecting member CL, the closing parts 72 of the protecting member CL come in contact with the end parts 11B in the X direction of the ejection head 11. Therefore, the ejection head 11 is mounted on the protecting member CL, and both the ejection head 11 and the protecting member CL are positioned in the X direction as well as the Y direction. Thus, in the present embodiment, the closing parts 72 of the protecting member CL are configured to also be positioning parts for the ejection head 11.

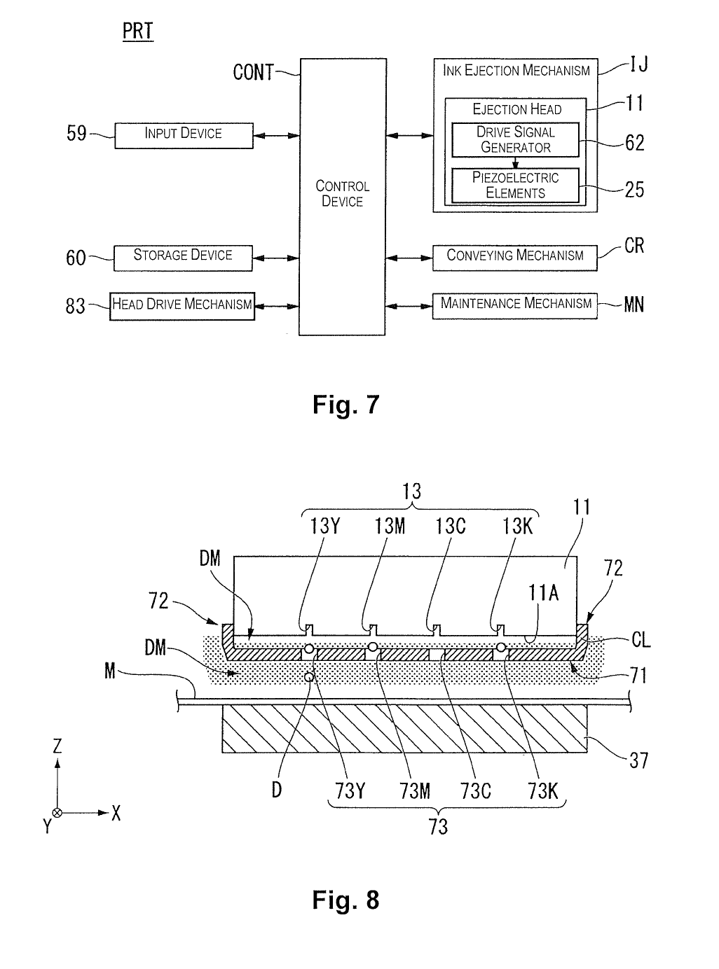

FIG. 7 is a block diagram showing the electrical configuration of the printing device PRT.

The printing device PRT in the present embodiment has the control device CONT for controlling all actions. Connected to the control device CONT are an input device 59 for inputting various pieces of information relating to the actions of the printing device PRT, and a storage device 60 on which various pieces of information relating to the actions of the printing device PRT are stored.

The components of the printing device PRT, including the ink ejection mechanism IJ, the conveying mechanism CR, the maintenance mechanism MN, and the head drive mechanism 83, etc., are connected to the control device CONT. The printing device PRT comprises a drive signal generator 62 for generating drive signals inputted to the drive unit including the piezoelectric elements 25. The drive signal generator 62 is connected to the control device CONT.

Inputted to the drive signal generator 62 are data showing the amount of change in the voltage value of the discharge pulse inputted to the piezoelectric elements 25 of the ejection head 11, and a timing signal for regulating the timing with which the discharge pulse voltage is varied. The drive signal generator 62 generates drive signals of the discharge pulse and the like on the basis of the inputted data and timing signal.

The following is a description of the actions of the printing device PRT configured as described above.

When the printing action is performed by the ejection head 11, the control device CONT causes the recording medium M to be placed on a support surface (not shown) by the conveying mechanism CR. After the recording medium M has been placed, the control device CONT inputs a drive signal from the drive signal generator 62 to the piezoelectric elements 25 on the basis of image data of the image being printed.

When the drive signal is inputted to the piezoelectric elements 25, the piezoelectric elements 25 expand and contract and ink D is ejected from the nozzles 13. At this time, ink mist is sometimes produced by the air pressure when the ink D is ejected. When this ink mist spreads, the ink mist adheres to the ejection surface 11A of the ejection head 11, for example, and the ejection surface 11A is dirtied.

In the present embodiment, since the protecting member CL is attached to the ejection head 11, the ink mist can be prevented from spreading to the ejection surface 11A even when an ink mist DM is produced as shown in FIG. 8. The ink mist DM produced between the ejection surface 11A and the protecting member CL can also be made to adhere to the +Z surface of the facing part 71 of the protecting member CL. Therefore, the ejection surface 11A can be prevented from being dirtied by the ink mist DM.

In the protecting member CL, since open parts 73 are provided to positions corresponding to the nozzle rows L (the nozzles 13) as shown in FIG. 8, the ink droplets D ejected from the nozzles 13 pass through the open parts 73 and adhere to the recording medium M. Therefore, the printing action is not obstructed and the ink mist DM can be prevented from adhering to the ejection surface 11A. The desired image is formed on the recording medium M by the ink droplets D ejected from the nozzles 13.

When the maintenance action is performed on the ejection head 11, the control device CONT actuates the head drive mechanism 83 and moves the ejection head 11 in the +Z direction, for example. This action causes the ejection head 11 to be released from being mounted on the protecting member CL. Once the ejection head 11 has been placed in a detached state, the control device CONT moves the maintenance mechanism MN in the −Z direction of the ejection head 11, for example, and causes the recording medium M to perform the maintenance action.

The control device CONT may also cause the maintenance action to be performed on the −Z surface of the protecting member CL. In this case, the wiping component W is moved relative to the −Z surface of the facing part 71 and made to wipe this surface clean, for example, while the ejection head 11 remains mounted on the protecting member CL.

According to the present embodiment as described above, since the ejection surface 11A is covered by the protecting member CL, the ink mist DM produced during ejecting by the ejection head 11 can be prevented from adhering to the ejection surface 11A. Since the open parts 73 are provided to positions corresponding to the plurality of nozzles 13, the ejecting action by the ejection head 11 is not hindered. Additionally, when there is a mist between the ejection surface 11A and the protecting member CL, for example, part of this mist is made to adhere to the protecting member CL (the +Z surface of the facing part 71), and the adhering of the ink mist DM to the ejection surface 11A can therefore be kept to a minimum.

The technological range of the present invention is not limited to the embodiment described above; suitable modifications can be made so long as they do not deviate from the scope of the present invention.

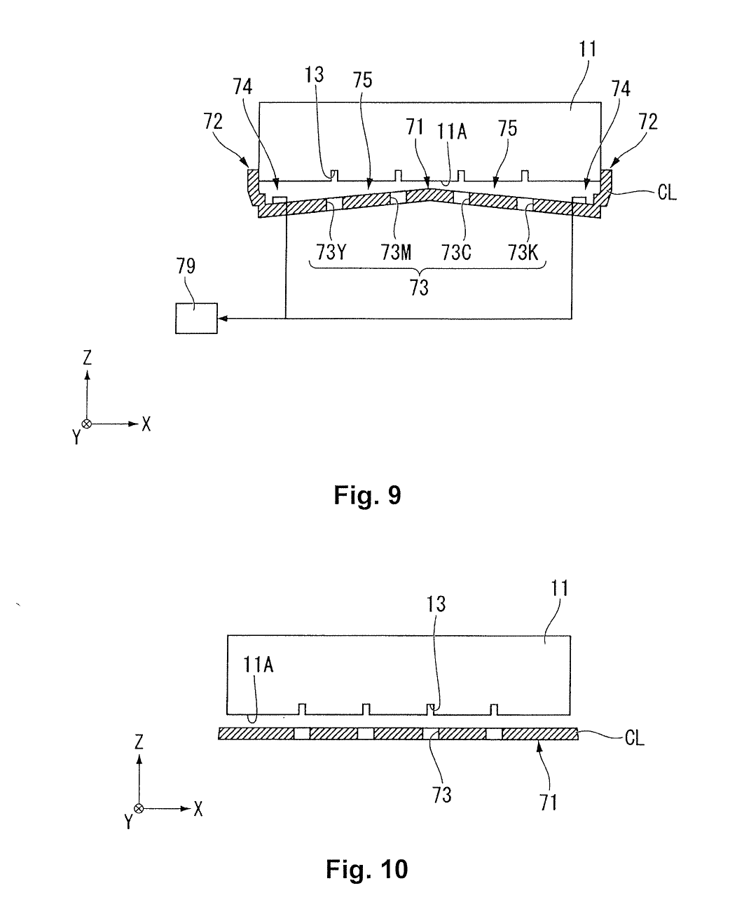

For example, the configuration of the embodiment described above may also have a recovery system 79 for recovering ink connected to both ends (recovering parts) 74 in the X direction of the protecting member CL, as shown in FIG. 9. In this configuration, the ink D absorbed by the protecting member CL can be recovered, and the protecting member CL can therefore be kept clean. The absorbing action of the protecting member CL can thereby be supported. In this configuration, since the recovery parts 74 are provided at the ends in the X direction of the protecting member CL, the flow passage of the recovery system 79 is easily designed.

The protecting member CL may also be configured having inclined parts 75 for guiding the liquid from the open parts 73 to the recovery parts 74 as shown in FIG. 9. In this case, the ink absorbed in the protecting member CL easily reaches the recovery parts 74. The efficiency of ink recovery can thereby be increased.

In the embodiment described above, for example, an example of a configuration was described in which closing parts 72 were provided to the +X end and the −X end of the protecting member CL, but the configuration is not limited to this example; closing parts 72 need not be provided as shown in FIG. 10. A protecting member CL is placed between the recording medium M and the ejection surface 11A in this configuration as well, and ink mist can therefore be prevented from adhering to the ejection surface 11A. Dirtying of the ejection surface 11A can be prevented even when the protecting member CL has this simpler configuration.

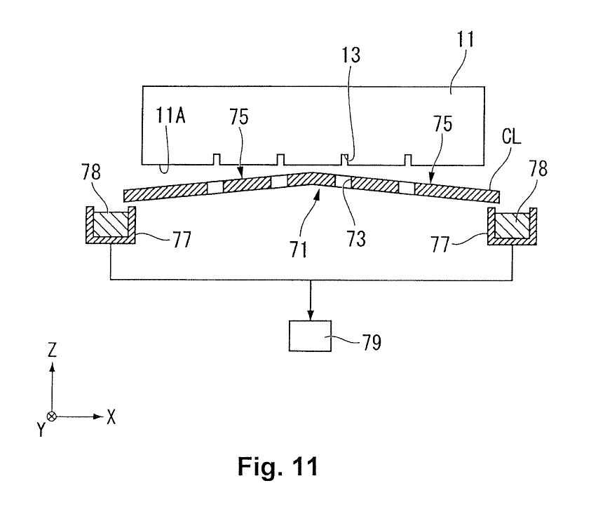

In a configuration having no closing parts 72, separate containers 77, ink-absorbing members 78, and other components may be provided at both the +X side and the −X side of the protecting member CL, and the recovery system 79 may be connected to the containers 77 or the ink-absorbing members 78, as shown in FIG. 11, for example. In this case, the containers 77 and the ink-absorbing members 78 are the recovery parts.

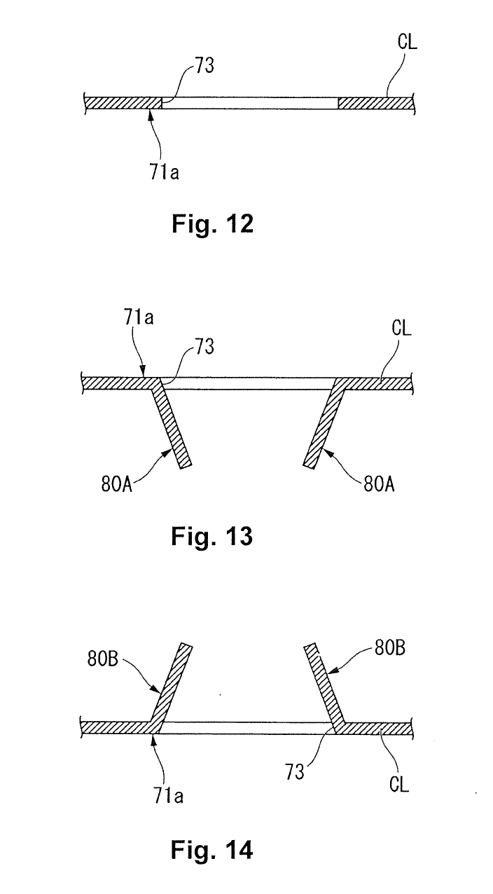

Suitable modifications can also be applied to the shapes of the peripheral edges 71a of the open parts 73 in the facing part 71 of the protecting member CL, as shown in FIGS. 12 through 14. The peripheral edges 71a can have a flat shape as shown in FIG. 12, for example. In this case, the protecting member CL can be manufactured easily.

The peripheral edges 71a may also be configured having protrusions 80A which protrude toward the recording medium M, as shown in FIG. 13, for example. This configuration regulates the movement of the ink mist from the −Z side to the +Z side, and the ink mist can therefore be prevented from entering the ejection surface 11A through the open parts 73. The ink discharge rate increases because the portions enclosed by the protrusions 80A gradually narrow in the direction of ink discharge (the −Z direction).

The peripheral edges 71a may also be configured having protrusions 80B which protrude toward the ejection surface 11A, as shown in FIG. 14, for example. In this configuration, the surface area of the protecting member CL is increased, and the portion where the ink mist adheres can therefore be enlarged. The surface of the facing part 71 of the protecting member CL that faces the recording medium M (the −Z side surface) is also flat, and wiping and other maintenance actions are therefore easily performed on the −Z side surface, for example.

In the embodiment described above, an example of a configuration was described in which the protecting member CL was formed from a porous material, but the configuration is not limited thereto. For example, the protecting member CL may be formed from resin material that does not absorb ink, such as plastic, for example. In this case, a configuration that absorbs ink can be achieved in the protecting member CL such as is described in the above embodiment by affixing a sheet (an absorbing member) formed from a porous material over the entire surface of the protecting member CL.

In the above description, an inkjet printer and ink cartridges were used, but it is also acceptable to use a liquid ejection device which ejects or discharges another liquid other than ink, and a liquid container for storing this liquid. Also applicable are various liquid ejection devices which comprise a liquid ejection head or the like for discharging droplets in minutely small amounts. The term “droplets” refers to the state of the liquid discharged from the liquid ejection device, including that which leaves traces in the shape of grains, tear-drops, and threads. The liquid referred to herein is preferably a material which can be ejected by the liquid ejection device.

For example, the material need only be in the state of a liquid which includes not only fluids such as liquids of high and low viscosity, sols, gels, other inorganic solvents, organic solvents, solutions, liquid resins, and liquid metals (metal melts); and liquids as one state of the substance; but also includes liquids containing particles of functional materials composed of pigments, metal particles, or other solids which are dissolved, dispersed, or mixed in a solvent. Typical examples of the liquids include ink such as the ink described in the embodiment described above, liquid crystal, and the like. The term “ink” used herein includes common water-based ink and oil-based ink, as well as gel ink, hot melt ink, and other various liquid compositions.

Specific examples of the liquid ejection device include liquid ejection devices which eject a liquid containing an electrode material, a coloring material, or the like in the form of a dispersion or a solvent, which is used in the manufacture of liquid crystal displays, EL (electroluminescence) displays, surface-emitting displays, color filters, and the like, for example; liquid ejection devices which eject a biological organic substance used to manufacture biochips; liquid ejection devices which are used as precision pipettes and which eject a liquid as a test sample; printing devices, micro dispensers; and the like.

Further options which may be used include liquid ejection devices which eject lubricating oil at pinpoints onto watches, cameras, and other precision instruments; liquid ejection devices for ejecting an ultraviolet curing resin or another transparent resin liquid onto a substrate in order to form a microscopic semispherical lens (optical lens) or the like used in an optical communication element or the like; and liquid ejection devices for ejecting an acid, an alkali, or another etching liquid in order to etch a substrate or the like. The present invention can be applied to any one of these types of ejection devices and liquid containers.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A liquid ejection device comprising:
a support member configured and arranged to support a conveyed medium conveyed in a predetermined direction;
a liquid ejection head having an ejection surface facing the support member, the ejection surface having a plurality of nozzles for ejecting a liquid onto the conveyed medium; and
a protecting member provided between the ejecting surface and the conveyed medium, arranged in a position fixed relative to the support member, and having an open part that allows passage of the liquid ejected from the liquid ejection head.

2. The liquid ejection device according to claim 1, wherein
the nozzles are arranged in one direction, and
the open part has a slit shape in an area corresponding to the nozzles.

3. The liquid ejection device according to claim 1, wherein
the protecting member has a closing part that contacts at least an end in the predetermined direction of the liquid ejection head to close off a space between the ejection surface and the protecting member.

4. The liquid ejection device according to claim 3, wherein
the closing part is also a positioning part between the liquid ejection head and the protecting member.

5. The liquid ejection device according to claim 1, wherein
the protecting member is made of a porous material configured to absorb the liquid.

6. The liquid ejection device according to claim 1, wherein
the protecting member has an absorbing member provided to an area separated from the open part to absorb the liquid.

7. The liquid ejection device according to claim 4, further comprising
a recovery part configured and arranged to recover the absorbed liquid.

8. The liquid ejection device according to claim 7, wherein
the protecting member has an inclined part configured and arranged to guide the liquid from the open part toward the recovery part.

9. The liquid ejection device according to claim 7, wherein
the recovery part is provided to an end of the protecting member in the predetermined direction in which the conveyed medium is conveyed.

10. The liquid ejection device according to claim 1, wherein
the protecting member has a protruding part protruding from a peripheral edge of the open part toward at least one of the liquid ejection head and the conveyed medium.

11. The liquid ejection device according to claim 1, further comprising
a fixing member fixing the support member and the protecting member.

12. The liquid ejection device according to claim 11, further comprising
a brace member attached to the fixing member and extending in a direction perpendicular to the ejection surface,
the liquid ejection head being configured and arranged to move along a direction in which the brace member extends.

13. The liquid ejection device according to claim 12, further comprising
a head drive mechanism configured and arranged to move the liquid ejection head along the direction in which the brace member extends,
the head drive mechanism being also a detaching mechanism configured and arranged to move the liquid ejection head to detach the liquid ejection head from the protecting member.
